(19) United States
(12) Patent Application Publication
(10) Pub. No.: US 2022/0253086 A1
(43) Pub. Date: Aug. 11, 2022

(54) CURRENT MIRROR CIRCUIT

(71) Applicant: SOCLE TECHNOLOGY CORP., Hsinchu (TW)

(72) Inventor: HSUAN-TSUNG WANG, Hsinchu (TW)

(21) Appl. No.: 17/561,819

(22) Filed: Dec. 24, 2021

(30) Foreign Application Priority Data
Feb. 9, 2021 (CN) 202110183356.3

(51) Int. Cl. G05F 3/26

(52) U.S. Cl. CPC G05F 3/262; G05F 3/242

(57) ABSTRACT

A current mirror circuit includes a current input circuit, a current output circuit and a negative feedback circuit. A first terminal of the current input circuit receives input current, a second terminal of the current input circuit is coupled to a second terminal of the current output circuit, a first terminal of the current output circuit outputs mirror current. The negative feedback circuit includes a first transistor and a second transistor, a first terminal of the first transistor is coupled to a third terminal of the current input circuit, a second terminal of the first transistor is coupled to a second terminal of the second transistor. The first terminal of the second transistor is coupled to the third terminal of the current output circuit, the third terminal of the second transistor is grounded. The current mirror circuit improves the output impedance.

### FIELD

The subject matter herein generally relates to electronic circuitry.

### BACKGROUND

Current mirror circuit is important in analog circuits, being used to accurately repeat an original current into one or more channels for a load. An accurate current level the same as or proportional to the original current for single or multiple circuit modules in a later stage is required. However, reducing the influence of the output node voltage on the output current is problematic.

Therefore, there is a room for improvement.

### BRIEF DESCRIPTION OF THE DRAWINGS

Implementations of the present disclosure will now be described, by way of embodiments, with reference to the attached figures.

FIG. 1 is a block diagram of an embodiment of a current mirror circuit.

FIG. 2 is a circuit diagram of an embodiment of the current mirror circuit.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

It can be understood that current mirror circuit is a basic unit in analog integrated circuit. A basic module circuit of current mode can be made up of the current mirror circuit, such as current mode transmitter, differentiator, and integrator. The current mirror circuit can also form current mode integrated circuits, such as continuous time filter, and A/D converter.

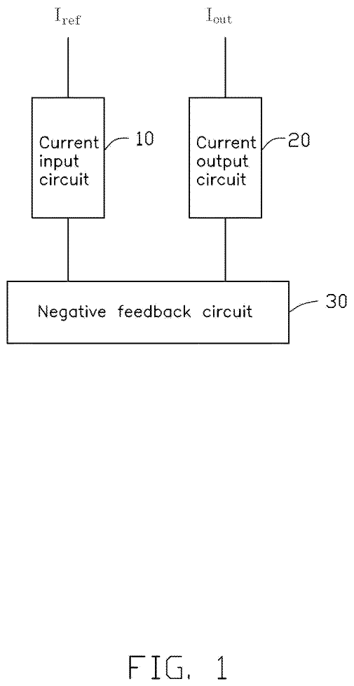

FIG. 1 illustrates a current mirror circuit 100 in accordance with an embodiment of the present disclosure.

In one embodiment, the current mirror circuit 100 includes a current input circuit 10, a current output circuit 20, and a negative feedback circuit 30.

In the embodiment, a first terminal of the current input circuit 10 receives an input current, and a second terminal of the current input circuit 10 is electrically connected to a second terminal of the current output circuit 20. The current output circuit 20 outputs mirror current Iₒᵤₜ according to the input current, and a first terminal of the current output circuit 20 outputs the mirror current Iₒᵤₜ. The negative feedback circuit 30 is electrically connected between a third terminal of the current input circuit 10 and a third terminal of the current output circuit 20, to form a negative feedback resistor.

In one embodiment, the current mirror circuit 100 further includes a common gate circuit 40, and the common gate circuit 40 is electrically connected between the first terminal of the current input circuit 10 and the first terminal of the current output circuit 20.

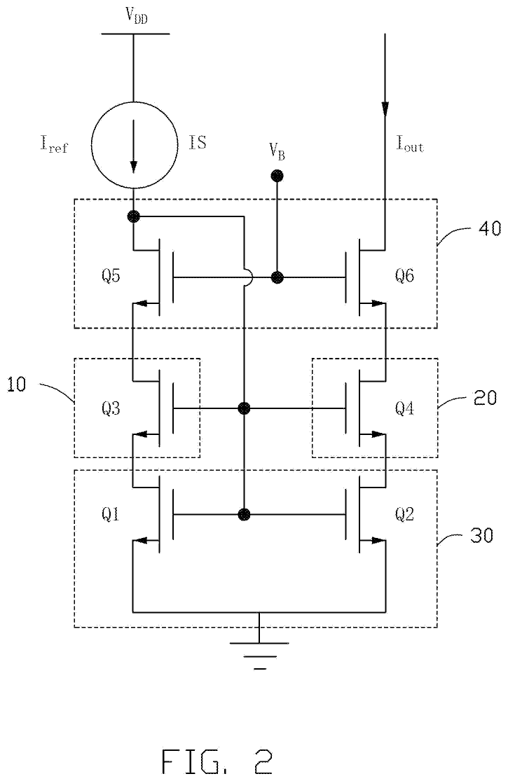

FIG. 2 shows a circuit diagram of the current mirror circuit 100 in accordance with an embodiment of the present disclosure.

The negative feedback circuit 30 includes a first transistor Q1 and a second transistor Q2. The current input circuit 10 includes a third transistor Q3. The current output circuit 20 includes a fourth transistor Q4. The common gate circuit 40 includes a fifth transistor Q5 and a sixth transistor Q6.

In the embodiment, a first terminal of a current source IS is electrically connected to a voltage V_{DD}, and a second terminal of the current source IS is electrically connected to a first terminal of the fifth transistor Q5, providing input current. Relative to the load impedance, the internal resistance of the current source IS is relatively large, and fluctuations in the load impedance do not change the magnitude of the current.

In the embodiment, a second terminal of the fifth transistor Q5 is electrically connected to a second terminal of the sixth transistor Q6, and a third terminal of the fifth transistor Q5 is electrically connected to a first terminal of the third transistor Q3. A first terminal of the sixth transistor Q6 outputs the mirror current Iₒᵤₜ, and a third terminal of the sixth transistor Q6 is electrically connected to a first terminal of the fourth transistor Q4.

In the embodiment, an external bias voltage V_{B} is electrically connected between the second terminal of the fifth transistor Q5 and the second terminal of the sixth transistor Q6. This provides a bias for the fifth transistor Q5 and the sixth transistor Q6, enabling the fifth transistor Q5 and the sixth transistor Q6 to work in a saturation region or state.

In the embodiment, the fifth transistor Q5 and the sixth transistor Q6 form a common gate transistor.

The first terminal of the third transistor Q3 is electrically connected to the third terminal of the fifth transistor Q5, a second terminal of the third transistor Q3 is electrically connected to a second terminal of the fourth transistor Q4, and a third terminal of the transistor Q3 is electrically connected to a first terminal of the first transistor Q1.

The first terminal of the fourth transistor Q4 is electrically connected to the third terminal of the sixth transistor Q6, and a third terminal of the fourth transistor Q4 is electrically connected to a first terminal of the second transistor Q2.

In the embodiment, a second terminal of the current source IS is electrically connected to the second terminal of the third transistor Q3 and the second terminal of the fourth transistor Q4, enabling the third transistor Q3 and the fourth transistor Q4 to work in saturation region or state.

The first terminal of the first transistor Q1 is electrically connected to the third terminal of the third transistor Q3, a second terminal of the first transistor Q1 is electrically connected to a second terminal of the second transistor Q2, and the first transistor Q1 is electrically connected to the second terminal of the second transistor Q2. The third terminal of the first transistor Q1 is grounded.

The first terminal of the second transistor Q2 is electrically connected to the third terminal of the fourth transistor Q4, and the third terminal of the second transistor Q2 is grounded.

In the embodiment, the second terminal of the second transistor Q2, the second terminal of the third transistor Q3, and the second terminal of the fourth transistor Q4 are electrically connected to the second terminal of the first transistor Q1. The second terminal of the transistor Q1 and the second terminal of the second transistor Q2 are electrically connected to the current source IS, and the current source IS provides a bias voltage for the first transistor Q1 and the second transistor Q2, enabling the first transistor Q1 and the second transistor Q2 to work in the saturation region or state.

In the embodiment, the first transistor Q1, the second transistor Q2, the third transistor Q3, the fourth transistor Q4, the fifth transistor Q5, and the sixth transistor Q6 are field effect transistors (FETs).

Of the first transistor Q1, the second transistor Q2, the third transistor Q3, the fourth transistor Q4, the fifth transistor Q5, and the sixth transistor Q6, the first terminals are drain or source terminals of the FETs. Of the same transistors Q1 to Q6, the second terminals are gate terminals of the FETs. Of the same transistors Q1 to Q6, the third terminals are source or drain terminals of the FETs.

The working principles of the current mirror circuit 100 will be described taking the circuit diagram shown in FIG. 2 as an example. Take the first transistor Q1, the second transistor Q2, the third transistor Q3, the fourth transistor Q4, the fifth transistor Q5, and the sixth transistor Q6 as being N-type MOS transistors.

For a MOS transistor working in the saturation region, the current I_{D} flowing through its drain can be determined by the gate length L, the gate width W, the gate-source voltage V_{GS} and the threshold voltage Vₜₕ. Taking the NMOS transistor as an example, its drain current I_{D} satisfies the following formula:

$${I}_{D} = \frac{1}{2} {μ}_{n} {C}_{ox} \frac{W}{L} {( {V}_{GS} - {V}_{th} )}^{2}$$

It can be understood that I_{D} is the drain current of the MOS transistor, μₙ is the migration rate of electrons, Cₒₓ is the gate oxide capacitance per unit area, W/L is the oxide width-to-length ratio, and V_{GS}−Vₜₕ is the overdrive voltage. When the difference between the gate-source voltage and the threshold voltage of the MOS transistor is determined, the drain current of the MOS transistor is only determined by its aspect ratio.

Regarding the third transistor Q3 and the fourth transistor Q4, when the reference current I_{ref} of the current source IS flows through the first transistor Q1, a bias voltage is generated between the gate and the drain terminals of the third transistor Q3. The fourth transistor Q4 is biased by the bias voltage, and the width-to-length ratio of the fourth transistor Q4 is adjusted to obtain a corresponding ratio of mirror current Iₒᵤₜ. The ratio of the mirror current Iₒᵤₜ to the reference current I_{ref} satisfies the following formula:

$$\frac{{I}_{out}}{{I}_{ref}} = \frac{{I}_{D} \text{?}}{{I}_{D 4}} = \frac{( W / L ) \text{?}}{( W / L ) \text{?}} \\ \text{?} \text{indicates text missing or illegible when filed}$$

The channel length modulation effect affects the drain current of the MOS transistor.

When the MOS transistor works in the saturation region, its drain terminal voltage affects the drain current, and its drain current satisfies the following formula:

$${I}_{D} = \frac{1}{2} {μ}_{n} {C}_{ox} \frac{W}{L} {( {V}_{GS} - {V}_{th} )}^{2} ( 1 + λ {V}_{DS} )$$

λ is the channel length modulation factor, and V_{DS} is the drain-source voltage.

Ohm's law provides that the branch current and branch voltage satisfy the following formula:

$$I = \frac{V}{R}$$

Therefore, the output node impedance can be increased when it is necessary to reduce the influence of the output node voltage on the output current.

Regarding the fifth transistor Q5 and the sixth transistor Q6, the fifth transistor Q5 and the sixth transistor Q6 are common gate transistors, and the third transistor Q3 and the fourth transistor Q4 are common source transistors. The fifth transistor Q5 and the sixth transistor Q6 are biased by an external bias voltage V_{B}, and the fifth transistor Q5 and the sixth transistor Q6 can work in the saturation region.

The intrinsic gain of the common-gate transistor to the output impedance satisfies the following formula:

Aᵥᵣₒᵤₜ=gₘrₒ

Aᵥᵣₒᵤₜ is the gain generated by the output impedance, gₘ is the transconductance, and rₒ is the equivalent resistance of the MOS transistor.

In the structure of the cascade current mirror circuit 100 composed of the third transistor Q3, the fourth transistor Q4, the fifth transistor Q5, and the sixth transistor Q6, the impedance of output node satisfies the following formula:

rₒᵤₜ=gₘ₆rₒ₆rₒ₄

rₒᵤₜ is the impedance of the output node, gₘ₆ is the transconductance of the sixth transistor Q6, rₒ₆ is the equivalent resistance of the sixth transistor Q6, and rₒ₄ is the equivalent resistance of the fourth transistor Q4.

In the embodiment, the output impedance is increased by adding a grid transistor.

Regarding the first transistor Q1 and the second transistor Q2, these are biased in the linear region, and they can be used as source feedback resistors.

When the mirror current Iₒᵤₜ increases in amplitude due to the fluctuation of the output node voltage, the voltage drop on the second transistor Q2 of the source feedback resistor increases while the bias voltage remains unchanged. The gate-source voltage on the fourth transistor Q4 decreases, to suppress the increase in output current amplitude.

The gate potential of the first transistor Q1 and the second transistor Q2 is the same as the gate potential of the third transistor Q3. The first transistor Q1 and the second transistor Q2 can work in the linear region, and the current satisfies the following formula:

$${I}_{D} = \frac{1}{2} {μ}_{n} {C}_{ox} \frac{W}{L} [ ( {V}_{GS} - {V}_{th} ) {V}_{DS} - \frac{1}{2} {V}_{DS}^{2} ]$$

By calculating the partial conductance of the current I_{D} to the drain-source voltage V_{DS}, the following formula can be obtained:

$$\frac{\partial {I}_{D}}{\partial {V}_{DS}} = {μ}_{n} {C}_{ox} \frac{W}{L} [ ( {V}_{GS} - {V}_{th} ) - {V}_{DS} ]$$

Then the impedance at both terminals of the drain source satisfies the following formula:

$${R}_{ds} = \frac{1}{{μ}_{n} {C}_{ox} \frac{W}{L} [ ( {V}_{GS} - {V}_{th} ) - {V}_{DS} ]}$$

Since the circuit has not only a cascade current mirror, but also a source feedback resistance, the output impedance satisfies the following formula:

rₒᵤₜ=gₘ₆rₒ₆gₘ₄rₒ₄R_{ds}

The MOS transistors working in the linear region are used as resistors to further increase the output impedance.

In a MOS integrated circuit process, the volume or area of the MOS device is smaller than that of the resistance device, and any mismatch of the MOS device is much smaller than that of a resistance device. The mismatch of the resistance device greatly improves the accuracy of the output current.

The current mirror circuit 100 increases the output impedance by providing a negative feedback circuit 30 and a common gate circuit 40, the negative feedback circuit being a MOS transistor device. Compared with a resistance device, in the MOS integrated circuit process, the area of the MOS device is larger than that of the resistance device, and a mismatch of MOS devices is much smaller than that of resistive devices, greatly improving the accuracy of output current.

The current mirror circuit 100 increases the output impedance, thereby reducing the influence of the output node voltage on the output current.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A current mirror circuit, comprising:
a first terminal of a current input circuit receiving input current;
a current output circuit outputting mirror current according to the input current; wherein a first terminal of the current output circuit outputs the mirror current, and a second terminal of the current output circuit is electrically connected to a second terminal of the current input circuit; and
a negative feedback circuit comprising a first transistor and a second transistor;
wherein a first terminal of the first transistor is electrically connected to a third terminal of the current input circuit, a second terminal of the first transistor is electrically connected to a second terminal of the second transistor, and a third terminal of the first transistor is grounded; and
wherein a first terminal of the second transistor is electrically connected to a third terminal of the current output circuit, a third terminal of the second transistor is grounded, and the first transistor and the second transistor work in a linear region.

2. The current mirror circuit according to claim 1, wherein the current input circuit comprises a third transistor, a first terminal of the third transistor is used to receive the input current, a second terminal of the third transistor is electrically connected to the second terminal of the current output circuit, a third terminal of the third transistor is electrically connected to the first terminal of the first transistor, and the third transistor works in a saturation region.

3. The current mirror circuit according to claim 2, wherein the current output circuit comprises a fourth transistor, a first terminal of the fourth transistor is used to output the mirror current, a second terminal of the fourth transistor is electrically connected to the second terminal of the third transistor, a third terminal of the fourth transistor is electrically connected to the first terminal of the second transistor, and the third transistor works in the saturation region.

4. The current mirror circuit according to claim 1, wherein the second terminal of the second transistor, the second terminal of the third transistor, and the second terminal of the fourth transistor are electrically connected to the second terminal of the first transistor, the second terminal of the transistor and the second terminal of the second transistor are electrically connected to a current source, and the current source provides a bias voltage for the first transistor and the second transistor, and the first transistor and the second transistor work in the saturation region.

5. The current mirror circuit according to claim 3, wherein the current mirror circuit further comprises a common gate circuit; wherein the common gate circuit comprises a fifth transistor and a sixth transistor, a first terminal of the fifth transistor is used to receive the input current, a second terminal of the fifth transistor is electrically connected to a second terminal of the sixth transistor, and a third terminal of the fifth transistor is electrically connected to the first terminal of the third transistor, a first terminal of the sixth transistor is used to output the mirror current, and a third terminal of the sixth transistor is electrically connected to the first terminal of the fourth transistor.

6. The current mirror circuit according to claim 5, wherein an external bias voltage is electrically connected between the second terminal of the fifth transistor and the second terminal of the sixth transistor, to provide a bias for the fifth transistor and the sixth transistor, and the fifth transistor and the sixth transistor work in a saturation region.

7. The current mirror circuit according to claim 5, wherein the fifth transistor and the sixth transistor form a common gate transistor.

8. The current mirror circuit according to claim 1, wherein the first transistor and the second transistor are MOS transistors.

9. The current mirror circuit according to claim 3, wherein the third transistor and the fourth transistor are MOS transistors.

10. The current mirror circuit according to claim 5, wherein the fifth transistor and the sixth transistor are MOS transistors.

11. A current mirror circuit, comprising:
a first terminal of a current input circuit receiving input current;
a current output circuit outputting mirror current according to the input current; wherein a first terminal of the current output circuit outputs the mirror current, and a second terminal of the current output circuit is electrically connected to a second terminal of the current input circuit;
a negative feedback circuit comprising a first transistor and a second transistor;
wherein a first terminal of the first transistor is electrically connected to a third terminal of the current input circuit, a second terminal of the first transistor is electrically connected to a second terminal of the second transistor, and a third terminal of the first transistor is grounded;
wherein a first terminal of the second transistor is electrically connected to a third terminal of the current output circuit, a third terminal of the second transistor is grounded, and the first transistor and the second transistor work in a linear region; and
wherein the second terminal of the second transistor, the second terminal of the third transistor, and the second terminal of the fourth transistor are electrically connected to the second terminal of the first transistor, the second terminal of the transistor and the second terminal of the second transistor are electrically connected to a current source, and the current source provides a bias voltage for the first transistor and the second transistor, and the first transistor and the second transistor work in the saturation region.

12. The current mirror circuit according to claim 11, wherein the current input circuit comprises a third transistor, a first terminal of the third transistor is used to receive the input current, a second terminal of the third transistor is electrically connected to the second terminal of the current output circuit, a third terminal of the third transistor is electrically connected to the first terminal of the first transistor, and the third transistor works in a saturation region.

13. The current mirror circuit according to claim 12, wherein the current output circuit comprises a fourth transistor, a first terminal of the fourth transistor is used to output the mirror current, a second terminal of the fourth transistor is electrically connected to the second terminal of the third transistor, a third terminal of the fourth transistor is electrically connected to the first terminal of the second transistor, and the third transistor works in the saturation region.

14. The current mirror circuit according to claim 13, wherein the current mirror circuit further comprises a common gate circuit; wherein the common gate circuit comprises a fifth transistor and a sixth transistor, a first terminal of the fifth transistor is used to receive the input current, a second terminal of the fifth transistor is electrically connected to a second terminal of the sixth transistor, and a third terminal of the fifth transistor is electrically connected to the first terminal of the third transistor, a first terminal of the sixth transistor is used to output the mirror current, and a third terminal of the sixth transistor is electrically connected to the first terminal of the fourth transistor.

15. The current mirror circuit according to claim 14, wherein an external bias voltage is electrically connected between the second terminal of the fifth transistor and the second terminal of the sixth transistor, to provide a bias for the fifth transistor and the sixth transistor, and the fifth transistor and the sixth transistor work in a saturation region.

16. The current mirror circuit according to claim 14, wherein the fifth transistor and the sixth transistor form a common gate transistor.

17. The current mirror circuit according to claim 11, wherein the first transistor and the second transistor are MOS transistors.

18. The current mirror circuit according to claim 13, wherein the third transistor and the fourth transistor are MOS transistors.

19. The current mirror circuit according to claim 14, wherein the fifth transistor and the sixth transistor are MOS transistors.
